(19) United States
(12) Patent Application Publication
(10) Pub. No.: US 2003/0064143 A1
(43) Pub. Date: Apr. 3, 2003

(54) Pectin-containing clear beverages

(75) Inventors: Timothy C. Gerrish, Kennett Square, PA (US); Joanne Haney, Wilmington, DE (US); Barbara McPherson, Napa, CA (US)

Correspondence Address: GREENBLUM & BERNSTEIN, P.L.C., 1941 ROLAND CLARKE PLACE, RESTON, VA, 20191, US

(73) Assignee: CP KELCO, Wilmington, DE (US)

(21) Appl. No.: 09/898,450

(22) Filed: Jul. 5, 2001

(51) Int. Cl. C12G 1/00

(52) U.S. Cl. 426/592

(57) ABSTRACT

A beverage product comprising a beverage and pectin, wherein the pectin has a calcium sensitivity of less than 20 cPs and the beverage product has a solution clarity of greater than 70% T.

### BACKGROUND OF THE INVENTION

1. Field of the Invention

The present invention relates to beverage products which contain pectin and are clear. The present invention also relates to a process for making a clear beverage product using a pectin which increases the viscosity of the beverage. The present invention further relates to a beverage concentrate comprising pectin which concentrate, upon reconstitution, provides a clear beverage. The present invention still further relates to a solid beverage concentrate comprising pectin and which solid concentrate, upon reconstitution, provides a clear beverage.

2. Description of Related Information

This application is related to application Ser. No. 09/589,888, filed Jun. 9, 2000; application Ser. No. 09/702, 098, filed Oct. 31, 2000, which is a divisional of application Ser. No. 08/161,634, now U.S. Pat. No. 6,159,503; application Ser. No. 08/890,983, filed July, 10, 1997, now U.S. Pat. No. 6,207,194 B1 which is a continuation of the same application Ser. No. 08/161,634; application Ser. No. 09/699,360, filed Oct. 31, 2000, which is a divisional of Ser. No. 08/161,635, now U.S. Pat. No. 6,143,346 and application Ser. No. 09/684,968, filed Oct. 10, 2000, which applications are all hereby incorporated by reference in their entireties.

3. Discussion of Background Information

The present invention is related to clear beverage products. Beverage products are well-known as illustrated by such non-limiting examples as water drinks, tea, coffee, wine including non-vintage, jug and boxed wines, beer, sports drinks, juices, colas and health drinks. The use of pectins as additives for beverage products is also known. The use of pectins as beverage product additives is desirable since pectin is a natural substance. Pectins are a group of structural polysaccharides from the cell walls of plants. They are deposited mainly in the early stages of growth when the cell area is increasing. The backbone of pectin comprises α-1,4 linked galacturonic acid units which are interrupted with a small number of 1,2 linked α-L-rhamnose units. In addition, pectin contains highly branched regions of neutral sugar side chains consisting mainly of rhamnose, galactose, arabinose and xylose. The dominant feature of pectin is the linear chain of α-1,4 linked D-galacturonic acid units in which varying proportions of the acid groups are present as methoxyl (methyl) esters. The term “degree of esterification” is intended to mean the extent to which free carboxylic acid groups contained in the polygalacturonic acid chain of the pectin have been esterified (e.g., by methylation) or in other ways rendered non-acidic (e.g., by amidation)

GENU VIS ® grade pectins (available from CPKelco) are commonly used to provide viscosity, body and mouthfeel to beverage products. However, since solutions of these pectin types are cloudy or turbid, their use is commonly limited to cloudy, opaque, pulpy, or non-clear beverage products. In addition, if a beverage product base contains polyvalent cations, such as calcium, magnesium or other charged materials such as proteins or very finely divided insoluble or colloidal particles, these materials can interact with the pectin to form a “cloud” or precipitate which imparts undesirable cloudiness, opaqueness or pulpiness to the beverage product.

Pectins are known to naturally exist in certain beverage products such as fruit juices. At least in part due to the presence of the pectin, the fruit juice is cloudy or opaque. Such fruit juices, for example apple juice, can be clarified to some degree by treating the pectins with enzyme to degrade the pectins to lower molecular weight. These treatments have the disadvantage of added expense for the treatment and the inability of the degraded pectin to provide the desired organoleptic properties to the juice.

U.S. Pat. No. 6,143, 346, to Glahn, the disclosure of which is incorporated herein by reference in its entirety, discloses that pectin extracted from typical sources, such as citrus peel, can be separated or fractionated into two distinct pectin fractions; one that is calcium sensitive (CSP) and one that is non-calcium sensitive (NCSP). Pectin from these distinct fractions can be characterized by their calcium sensitivity (CS) and their calcium sensitive pectin ratio (CSPR). This patent discloses that pectin compositions in accordance with the invention have CSPR, which is the ratio of CSP to the sum of CSP and NCSP greater than about 0.60. Also according to this patent, an additional composition in accordance with the invention comprises a citrus pectin having a degree of esterification less than about 80% and a ratio of NCSP to the sum of CSP and NCSP greater than 0.60. This patent discloses that the invention can be used in admixture with foodstuffs, whether liquid, liquid-containing or solid. This patent further discloses that the invention is particularly applicable in a number of listed food applications, including in beverage products.

U.S. Pat. No. 5,529,796 to Gobbo et al generally relates to a process for manufacturing “crystal clear” cold water soluble, chill stable, and acid stable ready-to-drink tea, as well as to the product produce thereby. According to one embodiment of this patent, powdered instant teas are substantially dissolved in water to form tea solutions which are then treated with high methoxy pectin. According to this patent, the type of pectin preferably used is a high methoxy pectin such as GENU JMJ® pectin. GENU VIS® pectin is also disclosed as being operable.

### SUMMARY OF INVENTION

According to a first aspect of the present invention, a beverage product comprises a beverage and pectin, wherein the pectin has a calcium sensitivity of less than 20 cPs and the beverage product has a solution clarity of greater than 70% transmittance (% T).

According to a second aspect of the present invention, a beverage product comprises a beverage and pectin, wherein the pectin has a calcium sensitivity of less than 20 cPs and a calcium sensitive pectin ratio of less than 10%, and the beverage product has a solution clarity of greater than 70% T.

According to another aspect of the present invention, a beverage product comprises a beverage and pectin, wherein the pectin has a calcium sensitivity of less than 20 cPs and a degree of esterification (DE) greater than 70, and the beverage product has a solution clarity of greater than 70% T.

According to another aspect of the present invention, the beverage further comprises at least one of vitamin, flavor, preservative color, mineral, sugar, natural sweetener, artificial sweetener and nutrients.

According to another aspect of the present invention, the pectin is non-calcium sensitive pectin (NCSP).

According to another aspect of the present invention, the beverage product further comprises charged material.

According to another aspect of the present invention, the beverage product further includes alcohol.

According to another aspect of the present invention, a process for making a beverage product comprises mixing pectin and a beverage, wherein the pectin has a calcium sensitivity of less than 20 cPs and the beverage product has a solution clarity of greater than 70% T.

According to another aspect of the present invention, a process for making a beverage product comprises mixing pectin and a beverage, wherein the pectin has a calcium sensitivity of less than 20 cPs and the beverage product has a solution clarity of greater than 70% T, and wherein the viscosity of the beverage product increases by at least 0.5 cP as a result of mixing with the pectin.

According to another aspect of the present invention, a process for making a beverage product comprises mixing pectin and a beverage, wherein the pectin has a clarity greater than 65% T and the beverage product has a solution clarity of greater than 70% T, and wherein the viscosity of the beverage product increases by at least 0.5 cP as a result of mixing with the pectin.

According to another aspect of the present invention, a pectin-containing beverage concentrate to be reconstituted with water or any other orally ingestible liquid as a drinkable liquid, comprises beverage concentrate and pectin, wherein the pectin has a calcium sensitivity of less than 20 cPs and the pectin-containing beverage concentrate, upon reconstitution, has a solution clarity of greater than 70% T.

According to another aspect of the present invention, a pectin-containing beverage concentrate to be reconstituted with water or any other orally ingestible liquid as a drinkable liquid comprises solid beverage concentrate and pectin, wherein the pectin has a clarity of greater than 65% T and wherein the pectin-containing beverage concentrate upon reconstitution has a solution clarity of greater than 70% T.

According to another aspect of the present invention, a pectin-containing beverage concentrate to be reconstituted with water or any other orally ingestible liquid as a drinkable liquid comprises beverage concentrate and pectin, wherein the pectin has a clarity of greater than 65% T and wherein the pectin-containing beverage concentrate upon reconstitution has a solution clarity of greater than 70% T.

These and other features, aspects, and advantages of the present invention will become better understood with reference to the following description and appended claims.

### DETAILED DESCRIPTION OF THE INVENTION

Unless otherwise stated, all percentages, parts, ratios, etc., are by weight.

Unless otherwise stated, a reference to a compound or component includes the compound or component by itself, as well as in combination with other compounds or components, such as mixtures of compounds.

Further, when an amount, concentration, or other value or parameter, is given as a list of upper preferable values and lower preferable values, this is to be understood as specifically disclosing all ranges formed from any pair of an upper preferred value and a lower preferred value, regardless of whether ranges are separately disclosed.

According to the present invention, a beverage product comprises a beverage and pectin, wherein the pectin has a calcium sensitivity of less than 20 cPs and wherein the beverage product has a solution clarity of greater than 70% T. The solution clarity of the beverage product could be at least about 80% T. The solution clarity of the beverage product could even be as high as at least about 90% T. Most preferably, the solution clarity of the beverage is greater than 95% T.

The term “beverage” is an art-recognized term not requiring further explanation. In any event, “beverage” refers to any potable liquid orally consumed. Non-limiting, illustrative examples of beverages include water, such as sparkling, carbonated, uncarbonated, still, flavored, non-flavored and mineral; sports drinks; juices, such as fruit, vegetable, juice blends, single strength, cocktail, juice drink, reconstituted, from concentrate, cider, carbonated, non-carbonated, sugar free diet, punch, powdered and mixes; soft drinks such as soda, carbonated, sugar-free, fountain, light, diet and tea; alcoholic such as bottled beer, draft beer, malt beverages, liquors; wine beverages such as vintage, non-vintage, jug and boxed wine, wine coolers, diluted wine beverage, full, low, and non-alcoholic, varietal and non-varietal and refreshing drinks such as ades. Beverage products in accordance with the present invention can also be present as concentrates which are reconstituted with water or any other orally ingestible liquid. The concentrate can be present as a concentrated liquid or as a solid. The beverage can further comprise at least one of vitamin, flavor, preservative, color, mineral, sugar, artificial sweetener, nutrient or any other additional ingredients used in beverages. Solid beverage concentrate, by way of non-limiting examples, includes solid forms such as frozen, freeze-dried, tablet, flaked, powder, crystals, granules, shaped solid such as sticks, ropes and films, etc.

“Processed” pectin as used hereinafter is intended to mean pectin which has been removed from its native environment, e.g., pectin extracted from peel such as citrus peel. It is known that even such processed pectin will still contain some amount of the starting material from which it has been separated, e.g. citrus peel. In terms of purity of pectin, the processed pectin, upon separation from its native environment, should be at least about 85% pectin (weight basis) based on the total amount of pectin and peel. Preferably, the amount of pectin should be at least about 90%. Most preferably the pectin purity is at least about 95%. It is known that native pectin is found in certain beverages such as apple juice. It is also known that such native pectin plays a partial role in imparting cloudiness or opaqueness to the apple juice. If it is desired to increase the clarity of the juice, this is commonly accomplished by treating the apple juice containing the native pectin with enzyme to degrade the pectin. Not only do such processes suffer the disadvantage of added expense, but the degraded pectin loses its ability to impart desired organoleptic properties to the juice. The present invention is believed to be unique, inter alia, in that it allows for the use of pectin to impart desirable organoleptic properties to a beverage while still allowing for exceptional clarity in the beverage. Clarity of the beverage is determined as follows:

Apparatus

1. Pipette

2. Test Beverage

3. Spectrophotometer

Procedure

1. Stir test beverage for 2 to 3 minutes.

2. Calibrate the Spectrophotometer (set at 655 nm) at 100% transmission using deionized water.

3. Remove a small sample (2-3 mls.) of test beverage and place into a cuvette.

4. Measure the percent transmission (%T) of the sample at 655 nm.

According to the present invention, the pectin preferably has a molecular weight of at least 50,000 g/mole, the beverage product having a solution clarity of greater than 70% T. In a preferred embodiment of the invention, the molecular weight of the pectin is at least about 75,000 g/mole. In amore preferred embodiment, the molecular weight is at least about 100,000 g/mole. The molecular weight of the pectin is determined by measuring the relative viscosity of a 0.1% pectin solution using Na-hexametaphosphate as follows:

Apparatus

1. Witeg-Ostwald-viscosimeters or similar with 100 to 150 sec. outlet time for water (25° C.)

2. Transparent thermostated water bath, 25.0° C.±0.3° C.

3. Digital stop watch

Reagents

Na-hexametaphosphate solution:

20.0 g Na-hexametaphosphate is dissolved in 1800 ml ion exchanged deaerated (boiled) water

pH is adjusted to 4.50±0.05 with 1 M HCl

The solution is diluted with ion exchanged, deaerated (boiled) water until 2000 ml.

Procedure

1. Used viscosimeters must be cleaned as stated in section: Cleaning/maintenance of viscosimeters.

2. Outlet time for hexametaphosphate solution is measured (section: Measuring of outlet time) on the viscosimeters used for every time a new hexametaphosphate solution is prepared and for every new working day where pectin solutions are being measured.

3. Immediately before measuring, the necessary quantity of hexametaphosphate solution is filtered through a glass filter #3

4. The pectin sample system for molecular weight determination is made as follows:

a) Weigh 2.000 g pectin in a 250 ml glass beaker

b) Add 100 ml acid alcohol (60% IPA +5 ml HCl fuming 37%) and stir on a magnetic stirrer for 10 minutes

c) Filter through a dried, weighed glass filter crucible

d) Rinse the beaker completely with 6×15 ml acid alcohol

e) Wash with 60% IPA until filtrate is chloride free* * Chloride test: Transfer approximately 10 ml filtrate to a test tube, add approximately 3 ml 3 N HNO₃, and add a few drops of AgNO₃. The filtrate will be chloride-free if the solution is clear, otherwise there will be a precipitation of silver chloride

f) Wash pectin with 20 ml 100% isopropyl alcohol (IPA)

g) Dry the sample for 2.5 hours at 105° C.

h) Approximately 90 g hexametaphosphate solution is weighed in a tared beaker with magnet

i) 0.1000 g acid washed pectin from f) is gradually added while stirring

j) Heat the solution to 70° C. while stirring; keep stirring until the pectin is completely dissolved

k) Cool the solution to 25° C.

l) Add additional hexametaphosphate solution to achieve total solution weight of 100 g

m) Filter through a #3 glass filter

5. For every molecular weight determination the outlet time is measured (section: Measuring the outlet time) for the pectin/hexametaphosphate solution on two different viscometers

6. Molecular weight is calculated (section:Calculation) separately for each viscosimeter using the latest measured outlet time for hexametaphosphate solution on the viscosimeter in question

7. Should the difference between two calculated molecular weights be less than 3500 the mean value is calculated. Round off the value to the nearest multiple of 1000 and that will be the result of the method.

8. Should the difference between the two calculated molecular weights be 3500 or more the viscosimeters should be cleaned and a new measuring of outlet time for hexametaphosphate solution should be performed.

Measuring the Outlet Time

1. The viscosimeter is rinsed twice with the pectin sample solutions

2. Pour 5.00 ml of the sample in the viscosimeter and place it in the thermostated water bath at 25.0° C.±0.3° C. at least 15 minutes prior to measuring

3. Time is measured on two outlets. Should the difference between the times be more than x seconds the measuring is repeated until three outlet times which differ no more than x seconds is obtained

x=0.2 seconds on measuring hexametaphosphate solution

x=0.4 seconds on measuring samples

4. The outlet time which is needed for further calculations is the mean value of the above mentioned two or three identical or almost identical measuring results.

Cleaning/Maintenance of Viscosimeters

1. Having completed work: rinse once with ion exchanged water and then once with 1 M HCI.

2. Soaking between working days: 1 M HCI.

3. New working day before measurings: rinse twice in ion exchanged (not deaerated) boiled water.

4. Clogging: probe carefully with a thin copper wire.

Calculation

The relative viscosity, nᵣ, is calculated, as follows:

$${n}_{r} = \frac{( {t}_{0} - K / {t}_{0} )}{( {t}_{0} - K / {t}_{h} )}$$

Where tₒ and tₕ are outlet times for pectin solution and hexametaphosphate solution, respectively.

K is calculated as follows:

$$K = \frac{Q \times {t}_{v}^{2}}{Q + ( 0.266 - L - {t}_{v} )}$$

where Q=volume of viscosimeter bulb in cm³, L=length of capillary tube in cm and tᵥ=outlet time for water in seconds.

The molecular weight of pectin is calculated as follows:

$$M = \frac{( {n}_{r}^{1 / P} - 1 ) \times P}{k \times C}$$

Where P is fixed at 6 and k is fixed at 4.7×10⁻⁵ Mol/g; C is the weight percentage of pectin in the sample system, i.e., 0.1% resulting in the following equation for calculating molecular weight:

M=1.277.10⁶(nᵣ^{1/6}−1)g/mol.

In accordance with the present invention, the pectin preferably has a clarity greater than 65% T. More preferably, the clarity of the pectin is greater than about 75% T. Even more preferably, the clarity of the pectin is greater than about 85% T. It is still more preferred that the clarity of the pectin is greater than about 90% T. The upper limit is limited only by the amount of clarity that can be practically achieved. Accordingly, the upper limit for clarity of the pectin is 100% T. The clarity of the pectin is determined as a 1% pectin solution with a spectrophotometer as follows:

Apparatus

1. Beaker, 250 ml

2. 100% IPA

3. Magnet

4. Magnet stirrer

5. Deionized water

6. Measuring flask, 100 ml

7. Pipette

8. Spectrophotometer

Procedure

1. Weigh 1 g pectin into a 250 ml beaker.

2. Moisten with 3 ml IPA.

3. Place a magnet in the beaker.

4. Place the beaker on a magnet stirrer.

5. Add 96 ml deionized water while stirring

6. Stir until the pectin is dissolved.

7. Measure the transmission or absorbance on a spectrophotometer at 655 nm.

8. State the results as %T (transmission) or %Abs (absorbance).

In accordance with present invention, the pectin preferably has a calcium sensitivity (CS) less than 20 cPs (centipoise). More preferably, the pectin has a calcium sensitivity less than about 15 cPs. Even more preferably, the pectin has a calcium sensitivity less than about 10 cPs. Most preferably, the pectin has a calcium sensitivity less than about 5 cPs. The lower limit of calcium sensitivity would depend only on the lowest calcium sensitivity that could practically be achieved. On this basis, the lower limit is 1 cP. The calcium sensitivity of the pectin is determined as follows:

Apparatus

1. Plate magnetic stirrer, IKA MAG EOA 9

2. Magnetic stirrer, JK IKA-Combimag REO

3. Viscosity glass, 50×110 mm (Holm & Halby)

4. Dispenser, 25 ml

5. Automatic pipette, 5 ml

6. Brookfield viscosimeter LVT

7. pH-meter

8. Technical balance

9. Analytical balance

10. TRIKA magnets, 42 mm

11. Cooling bath, thermostatically controlled at 25° C.

Reagents

1 M hydrochloric acid, HCl

1 M acetate buffer pH 4.75:500 mM CH₃COONa·3H₂O: 68.04 g/l and

500 mM CH₃COOH 100%: 28.6 ml/l

250 mM calcium chloride: (CaCl₂·2H₂O): 36.76 g/l

Ion exchanged water with a conductivity below 1.0 micro Siemens (μS)/cm must be used in all solutions.

Pectin Solution

Make up 400 g pectin solution with 2.4 g pure gum (0.6% sol.).

When testing samples which are not 100% gum (pure gum), correct according to the following formula (A=the gum % of the sample):

$$\frac{0.6 \times 400}{A} = \begin{matrix}\text{g sample with A \% gum for 400 g solution} \\ \text{with 0.6\% final concentration}\end{matrix}$$

Procedure

1. Weigh out the pectin (pure or sugar standardized) to 3 decimals.

2. Disperse the pectin into 250 ml boiling deionized water in a high-shear mixer.

3. Pour the solution into a tared beaker with magnet.

4. Pour additionally 100 ml deionized water into the mixer and add to the solution.

5. Cool the pectin solution to 25° C.

6. Adjust the pectin solution to pH 1.5 with 1 M HCl

7. Add additional deionized water to achieve 400 g of solution.

8. Weigh out 145 g±1 g pectin solution into a viscosity glass.

9. Place a TRIKA magnet in the glass

10. Add 5 ml 250 mM Ca⁺⁺ solution to the glass and mark it (+Ca⁺⁺) while stirring for 2 minutes.

11. Add 25 ml 1 M acetate buffer with dispenser to the glass while stirring vigorously, pH should now be approx. 4.2

12. Continue stirring for 2 min.

13. Remove the magnet and let the solutions rest at 25° C. for 12 hours.

14. The viscosity is measured with Brookfield LVT viscosimeter at 60 rpm. at 25° C. (use the thermostatically controlled water bath).

15. State the calcium sensitivity as viscosity (measured in cPs) of the solution with Ca⁺⁺

In accordance with the present invention, the pectin preferably has a calcium sensitive pectin ratio (CSPR) of less than 10%. More preferably, the pectin has a calcium sensitive pectin ratio of less than about 7%. Even more preferably, the pectin has a calcium sensitive pectin ratio of less than about 5%. Most preferably, the pectin has a calcium sensitive pectin ratio of less than about 1%. The lower limit for CSPR is limited only by the CSPR that can be practically achieved. On this basis the lower limit is zero. The lower limit is preferably about 0.5%. The lower limit could be as high as about 1%. As noted above in U.S. Pat. No. 6,143,346 entitled Pectin Process and Composition, to Glahn, which is incorporated herein by reference in its entirety, it is disclosed that commercially extracted pectins contain a mixture of a calcium sensitive fraction and a non-calcium sensitive fraction. The patent also discloses the discovery that such commercially extracted pectin mixtures can be separated into separate fractions one rich in calcium sensitive pectin and one rich in non-calcium sensitive pectin. The non-calcium sensitive fraction (NCSP) has been found to be particularly well-suited for use in the present invention. The calcium sensitive pectin ratio is an indication of the amount of calcium sensitive pectin to non-calcium sensitive pectin being used. The calcium sensitive pectin ratio is determined as follows:

A pectin sample of 0.2 g is weighed to the nearest mg (in a pretared 50 ml centrifuge tube weighed to the nearest mg), and is dissolved in 10 g of demineralized water by heating the tube to 70° C. The solution is cooled to approximately 20° C. This is done in duplicate. The pH of each solution is adjusted to 4.0.

The total amount of pectin in the solution is determined by adding 20 ml of 80% isopropyl alcohol to one of the tubes to precipitate the pectin. The precipitate is collected by centrifugation at 30,000 G for 30 minutes, washed twice with 60% isopropyl alcohol following up each wash with centrifugation. The precipitate is dried at 60° C. under vacuum to constant weight, and weighed to the nearest mg. Calculate the amount of pectin precipitated and divide by the initial weight of pectin added to that particular tube. This ratio is designated the A value of the pectin.

Add 10 ml of the following solution (which contains 60 mM calcium and 16 percent IPA) to the remaining 10 ml sample of pectin solution in a tared centrifuge tube:

387 g demineralized water

99 g 80% isopropyl alcohol (IPA)

4.4 g CaCl₂, 2H₂O

After mixing the two solutions, this results in a Ca-content of 30 mM and 8% IPA. The suspension of gel particles formed is left for 24 hours with occasional stirring. The gel particles are separated from the liquid phase by centrifugation at 30,000 G for 30 minutes. Carefully decant or siphon off the liquid phase and leave the gel particles in the tube.

The gel particles are washed twice in equal amounts of a solution containing 30 mM Ca and 8% IPA by vortexing and allowing the wash to equilibrate. The equilibration time is 24 hours for each washing. Following each wash, the gel particles are separated using centrifugation at 30,000 G for 30 minutes. The washing solution for this step can be prepared by diluting an aliquot of the 16% IPA-60 mM calcium solution with an equal volume of water.

The total amount of washed gel phase is then weighed after decanting off the liquid phase. The amount of pectin in the gel phase is determined by mixing the gel phase, weighed out to the second decimal with twice its value of 80% IPA, and then washed twice in 60% IPA. The precipitate is collected by centrifugation at 30,000 G for 30 minutes after each wash. The sample is then dried at 60° C. overnight under vacuum to constant weight to the nearest mg. The normalized amount of CSP pectin is determined by dividing this amount of pectin by the original amount of pectin weighed into the centrifuge tube. This is designated the B value.

The ratio of CSP to total amount of CSP and NCSP is calculated according to the formula:

$$CSPR = \frac{B}{A}$$

The ratio of NCSP to total amount of CSP and NCSP is found by subtracting the CSPR value from 1.

If a beverage base contains charged material such as polyvalent cations such as calcium or magnesium, proteins, or very finely divided insoluble or colloidal particles these materials can react with conventional pectins to form a “cloud” or a precipitate, both of which are undesirable in a clear beverage. The pectins according to the present invention are relatively insensitive to these charged materials which makes it possible to make clear beverages even in their presence.

In accordance with present invention, a process for making a beverage comprises mixing pectin and a beverage, wherein the pectin has a calcium sensitivity of less than 20 cPs and wherein the beverage has a solution clarity of greater than 70% T. Also in accordance with the present invention, a process for making a beverage comprises mixing pectin and a beverage, wherein the pectin has a clarity of at least 65% T and wherein the beverage has a solution clarity of greater than 70% T. As would readily occur to one of ordinary skill in the art having the benefit of the present disclosure, the mixing could take many well-known forms. For example, the pectin could be added to a batch of beverage or the beverage could be added to a pectin solution. If in solid form, solids of the beverage and the pectin can be mixed in any order or liquid pectin solution and beverage can be formed and then dried together. The other ingredients such as vitamin, flavor, preservative, color, mineral, sugar, artificial sweetener and nutrient can also be added in any known manner and in any order.

Illustrative, non-limiting examples of sugars include monosaccharides, disaccharides and polysaccharides. Suitable sugars for use in the present invention include, but are not limited to, xylose, ribose, glucose, mannose, galactose, fructose, dextrose, sucrose, maltose, partially hydrolyzed starch or corn syrup solids and sugar alcohols such as sorbitol, xylitol, mannitol, glycerine and combinations thereof. Mixtures of these sugars can also be used in accordance with the present invention.

Illustrative, non-limiting examples of artificial sweeteners include aspartame, sucralose, cyclamates, saccharine and mixtures thereof.

Illustrative, non-limiting examples of flavors include natural and/or artificial flavors such as mint (e.g., peppermint), menthol, cinnamon, vanilla, natural and/or artificial fruit flavors such as cherry, orange, strawberry, grape, lemon and lime, taste modifiers such as citric acid and mixtures thereof.

Illustrative, non-limiting examples of vitamins include Vitamin C in the form of ascorbic acid, B-complex group vitamins such as pantothenate, pyridoxine, p-aminobenzoic acid and riboflavin, Vitamin A, Vitamin D, Vitamin E such as tocopherol acetate, Vitamin B12, folic acid, niacin, biotin, carotene (Pro A) and mixtures thereof.

Illustrative, non-limiting examples of colors are annatto, beet powder caramel, carotene, cochineal extract, FD&C Green #3, FD&C Red #3, titanium dioxide and turmeric.

Illustrative, non-limiting examples of nutrients are betaine hydrochloride, choline chloride, inositol, linoleic acid, rutin, cystine, glutamic acid, lysine, arginine, leucine, isoleucine, methionine, phenylalanine, threonine and valine.

Illustrative, non-limiting examples of preservatives are butylated hydroxyanisole (BHA), butylated hydroxytoluene (BHT), propylgallate, nitrates, sorbic acid, acetic acid, benzoic acid, natamycin and p-hydroxybenzoate.

Illustrative, non-limiting examples of minerals are boric acid, calcium citrate, calcium carbonate, cobalt sulfate, cupric sulfate, cupric gluconate, ferric phosphate, iodine, magnesium sulfate, potassium chloride and zinc chloride.

In accordance with the present invention, as a result of mixing the pectins described herein with the beverage, the viscosity of the beverage product increases by at least 0.5 cP (centipoise). Preferably, the viscosity of the beverage increases by at least 0.75 cP as a result of mixing with the pectin. More preferably, the viscosity of the beverage increases by at least 1.0 cP as a result of mixing with the pectin. The viscosity of the beverage product could increase by up to 20 cPs. The preferred upper limit is 10 cPs. The most preferred upper limit for increase in beverage product viscosity is about 5 cPs. This increase in beverage viscosity imparts desirable organoleptic properties to the beverage. The increase in viscosity of the beverage as a result of mixing with the pectin is determined as follows:

Apparatus

1. Brookfield Viscometer, Model LVT, fitted with Ultra Low Adaptor

2. ULA-40Y water jacket

3. Spindle #85

Procedure

1. Load 16 millimeters of beverage sample in the Ultra Low Adaptor of the viscometer

2. Allow the temperature of the system to equilibrate to 25° C.

3. The viscometer is turned on

4. Set the measurement speed to 30 rpm

5. Take measurements when the reading stabilizes, usually about 1 minute

To obtain the sample viscosity, the reading is multiplied by the spindle/speed factor which is found in the Factor Finder table supplied with the viscometer. For this configuration, the viscosity is obtained using the equation

Viscosity=reading×(6/rpm)

Note: (6/rpm) is the spindle/speed factor; in this case speed is 30 rpm.

In another embodiment of the present invention, a pectin-containing beverage concentrate to be reconstituted with water or any other orally ingestible liquid as a drinkable liquid, comprises beverage concentrate and pectin having a calcium sensitivity of less than 20 cPs, wherein the pectin-containing beverage concentrate, upon reconstitution, has a solution clarity of greater than 70% T.

In another embodiment in accordance with the present invention, a pectin-containing beverage concentrate to be reconstituted with water or any other orally ingestible liquid as a drinkable liquid, comprises beverage concentrate and pectin, wherein the pectin has a clarity greater than 65% T and wherein the pectin-containing beverage concentrate, upon reconstitution, has a solution clarity of greater than 70% T.

In another embodiment in accordance with the present invention, a pectin-containing beverage concentrate to be reconstituted with water or any other orally ingestible liquid as a drinkable liquid, comprises solid beverage concentrate and pectin, wherein the pectin has a clarity greater than 65% T and wherein the pectin-containing beverage concentrate, upon reconstitution, has a solution clarity of greater than 70% T.

The pectin-containing concentrate can further comprise at least one of vitamin, flavor, preservative, color, mineral, sugar, natural sweetener, artificial sweetener and nutrient.

As noted above, U.S. Pat. No. 6,143,346, entitled Pectin Process and Composition, to Glahn, discloses that pectin starting material extracted from typical sources, such as citrus peel, can be separated or fractionated into two distinct pectin fractions, one that is calcium sensitive (CSP) and one that is non-calcium sensitive (NCSP). Pectin from these distinct fractions can be characterized by their calcium sensitivity (CS) and their calcium sensitive pectin ration (CSPR). The NCSP fraction of the disclosed process is particularly suitable for use in practicing the present invention. As already disclosed herein, such pectins have a CS of less than 20 cPs (centipoises). More preferably they have a CS of less than about 15 cPs. Even more preferably, they have a CS of less than about 10 cPs. Most preferably, they have a CS of less than about 5 cPs. Also as already disclosed herein, such pectins have a CSPR of less than 10%. Preferably, they have a CSPR of less than about 7%. More preferably, they have a CSPR of less than about 5%. Most preferably, they have a CSPR of less than about 1%. The preferred pectins in accordance with the present invention are those having a clarity greater than 65% T. More preferably, the pectins have a clarity greater than about 75% T. Even more preferably, the pectins have a clarity greater than about 85% T. Most preferably, the pectins have a clarity greater than about 90% T.

An illustrative, non-limiting, general description of methods suitable for making pectin for use in practicing the present invention follows:

In the above-noted U.S. Pat. No. 6,143,346 to Glahn, it is disclosed that the pectin starting material is preferably fractionated into a liquid phase which contains the NCSP fraction, and a gel phase which contains the CSP. According to Glahn, a solution, gel, or suspension of pectin starting material having a degree of esterification greater than about 60% is treated with a cation-containing preparation. The pectin starting material means pectin product obtained by separation of pectin from plant material. The pectin starting material could be, for example, the acid pectin extract after purification or it could be wet pectin cake obtained after treating the acid pectin solution with an alcohol. Further, the pectin starting material could be, for example, the dried or partly dried pectin in the pectin cake from precipitation, or it could be the dried, milled pectin powder as normally produced by pectin manufacturers.

The cation-containing preparation means any source of free cation. The cation is preferably a metal ion derived from salts selected from the group consisting of alkaline earth metal salts, alkali metal salts, transition metal salts, and mixtures thereof, provided that such salts are reasonably soluble in the solvent, e.g., water or water/alcohol mixtures.

When a metal ion is used as the cation, it is preferably selected from the group consisting of calcium, iron, magnesium, zinc, potassium, sodium, aluminum, manganese, and mixtures thereof. More preferably, the metal cations are selected from the group consisting of calcium, iron, zinc, and magnesium. Most preferably, the cation is calcium. Mixtures of two or more metal cations may be employed. However, if a monovalent metal cation is employed, a di- or trivalent metal cation, such as calcium, must also be present. Preferably, when such mixtures are used, one of the metal cations is calcium.

Examples of metal salts that can be used, provided they are reasonably soluble in the solvent, include, but are not limited to, calcium acetate, calcium nitrate, calcium acid phosphate, calcium carbonate, calcium chloride, calcium citrate, calcium dihydrogen phosphate, calcium formate, calcium gluconate, calcium glutamate, calcium glycerate, calcium glycerophosphate, calcium glycinate, calcium hydrogen phosphate, calcium hydroxide, calcium iodide, calcium lactate, calcium lactophosphate, calcium magnesium carbonate, calcium magnesium inositol hexaphosphate, calcium phosphate tribasic, calcium-o-phosphate, calcium propionate, calcium pyrophosphate, calcium succinate, calcium sucrate, calcium sulfate, calcium tetraphosphate, iron (II) acetate, iron (III) acetate, iron (III) acetate hydroxide, iron (III) ammonium chloride, iron (III) ammonium citrate, iron (II) ammonium sulfate, iron (II) carbonate, iron (II) chloride, iron (III) chloride, iron choline citrate, iron (II) citrate, iron dextran, iran (II) formate, iron (III) formate, iron (III) hypophosphite, iron (II) lactate, iron (II) acetate, iron (II) phosphate, iron (III) potassium axalate, iron (III) pyrophosphate, iron (III) sodium citrate, iron (III) sodium pyrophosphate, iron (II) sulfate, iron (III) sulfate, magnesium ammonium phosphate, magnesium ammonium sulfate, magnesium carbonate, magnesium chloride, magnesium citrate, magnesium dihydrogen phosphate, magnesium formate, magnesium hydrogen phosphate, magnesium hydrogen-o-phosphate, magnesium hydroxide, magnesium hydroxide carbonate, magnesium lactate, magnesium nitrate, magnesium oxalate, magnesium oxide, magnesium phosphate, magnesium propionate, magnesium pyrophosphate, magnesium sulfate, zinc acetate, zinc ammonium sulfate, zinc carbonate, zinc chloride, zinc citrate, zinc formate, zinc hydrogen phosphate, zinc hydroxide, zinc lactate, zinc nitrate, zinc oxide, zinc phosphate, zinc phosphate monabasic, zinc phosphate tribasic, zinc-o-phosphate, zinc propionate, zinc pyrophosphate, zinc sulfate, zinc tartrate, zinc valerate, and zinc-iso-valerate.

The preferred salts are calcium salts such as calcium nitrate, calcium chloride, calcium hydroxide, calcium acetate, calcium propionate, calcium oxide, calcium gluconate, calcium lactate, and calcium carbonate. The most preferred calcium salt is calcium nitrate.

The cation-containing preparation preferably contains a di- or trivalent cation, and optionally at least one water miscible solvent. Under appropriate conditions, the polyvalent cation forms an insoluble cation pectinate salt or gel. The pectin does not form such an insoluble salt with said polyvalent cations, but diffuses out of said gel into the salt solution forming a separate pectin phase in the solution. The pectin can, accordingly, be separated into two or more fractions, one containing pectin that has reacted with the cation forming a gel matrix insoluble in the solvent. A second fraction, which does not form such a gel matrix, is transferred to the liquid phase until equilibrium is reached between the liquid phase and the liquid within the gel particles containing the matrix-forming pectinate.

The preferred cation is calcium ion in aqueous solution, optionally mixed with a solvent such as methyl alcohol, ethyl alcohol, propyl alcohol, isopropyl alcohol, acetone, ethyl acetate, and any other organic solvent that is miscible with water. When mixed with alcohol, care should be exercised to avoid alcohol levels that will result in precipitation of an insoluble pectin compound. The preferred solution is a mixture of alcohol and water. Most preferred is a mixture of isopropyl alcohol and water. The cation concentration can be varied over a wide range, with the upper limit being determined only by economic and practical considerations. It is preferred that the upper limit be about 60 millimoles cation per liter of reaction medium (60 mM). What is meant by reaction medium is what results from reacting the pectin starting material with the cation-containing preparation. A more preferred upper limit is about 45 mM cation. The lower limit is determined by that amount of cation that would provide the desired degree of separation into the fractions. The preferred lower limit is about 5 mM cation. A more preferred lower limit is about 10 mM cation, with about 30 mM being the most preferred lower limit.

The pH of the reaction medium influences the matrix-forming ability of the pectin starting material. If the pH is too low, no matrix is formed. It is believed that the pH should be at least about 2. The lower limit is preferably at least about 3, with about 4 being the most preferred. The upper limit of the pH is only determined by the stability of the pectin starting material under the combination of pH, temperature, and time being used. It is believed that the upper limit should be about 8. The preferred upper limit should be about 6, with about 5 being the most preferred upper limit.

The separation of the fractions is preferably performed as a separation into a gel phase and a liquid phase. The gel phase is predominantly the reaction product of the cation in the cation-containing preparation and the calcium-sensitive fraction present in the pectin starting material. The liquid phase is predominantly the pectin fraction in the starting material that does not form a gel with the cation-containing preparation. Various techniques conventional in the art could be used to perform the separation step. Preferably, the separation is performed by filtration using a washing solution to complete the separation. The composition of the preferred washing solution is comprised of the same cation-containing preparation used to treat the pectin starting material.

The gel fraction can be converted into its acid form or a salt of a monovalent metal or of ammonia by treating the alcohol precipitated fractions with an acid alcohol solution washing out the polyvalent metals. The fractions may then be partly or completely neutralized by washing with an alcohol solution of the desired salt. Alternatively, the fractions may be acidified before the alcoholic precipitation and subsequently washed with acid alcohol. Further, the fractions may be treated with an ion exchange resin carrying the desired monovalent cation and subsequently precipitated with alcohol. The preferred method depends on the further use of the fractions. The separated gel and liquid fraction may then be dehydrated, dried and milled. The dehydration is performed to remove the bulk of the water before the drying step. While any known technique could be used for dehydration, preferably the fraction is treated with alcohol. The water/alcohol phase formed in the dehydration is substantially removed by decantation, centrifugation or filtration using any conventional technique. Drying is accomplished by conventional techniques, e.g., atmospheric or reduced-pressure ovens, to a moisture content of less than 50% (weight basis), preferably less than 25%. The drying temperature should be maintained below the temperature at which the pectin starts to lose its properties, e.g., color, molecular weight, etc. Milling techniques are well-known and any known technique can be used to mill the pectin product to the desired particle size. It is most preferred that the final product be in dry, powder form, with a moisture content of 12% or less. Dry, powder form is intended to mean that the product be pourable without substantial caking. This is preferred for ease of use. The process could be either continuous or batch, with continuous being preferred.

The pectin can be obtained from various sources such as citrus peels from juice production, apple pomace from apple juice and cider production, sugar beet sunflower heads, and other vegetables or waste products from plants. The preferred pectins are citrus pectins. These pectins are preferably selected from at least on of lime, lemon, grapefruit and orange.

The NCSP of the present invention can be prepared by other techniques known in the art, such as reesterification of calcium sensitive pectins or mixtures of calcium and non-calcium sensitive pectins with methanol either by chemical or enzymatic methods. In addition, enzymes can also be used to remove or cut out carboxyl regions or blocks of carboxyl groups along the galacturonic acid backbone of the pectin starting material, and thus producing a non-calcium sensitive pectin. Examples of such enzymes preferably include, but are not limited to, polygalacturonase and pectate lyase.

Other mechanisms used to enhance the relative level of non-calcium sensitive pectin in plant tissue before it is extracted include transgenic or genetic modification techniques which can direct the specific production of non-calcium sensitive pectins in typical pectin raw materials such as citrus plants or as the result of expression in host plants such as sugar cane or corn. Finally, there are other extraction mechanisms that can be used to selectively isolate non-calcium sensitive pectin from plant tissue. Manipulation of particular pH or cation or mixtures thereof in the extraction mixture, or selection for one specific fraction of citrus peel over another, isolation separately of NCSP or CSP can also be achieved.

Regardless of which technique is used, however, without proper treatment, the liquid phase which contains the NCSP could include charged materials such as polyvalent cation (e.g. calcium or magnesium), protein or finely divided insoluble or colloidal particles. Even though the NCSP is non-sensitive to the presence of such materials, their absence from a beverage could further enhance the beverage product clarity. The clarity of the NCSP used in the various embodiments of the present invention can be improved through the use of filtration techniques to remove charged material from the NCSP liquid phase. Such filtration steps could include, by way of non-limiting illustrative example, tangential flow filtration, ultra filtration, diafiltration and reverse osmosis.

Particularly convenient for accomplishing the filtration of the charged material from the liquid NCSP phase is to pass the treated pectin starting material according to the Glahn patent over a screen which can be slanted at an angle to horizontal. The CSP phase, which exists in a gel form, flows down over the upper surface of the screen, while the NCSP liquid phase is allowed to pass downwardly through the screen. It has been found that, using this embodiment, the CSP gel performs the filtration of the charged particles from NCSP liquid phase. It has also been found that the use of a scraper blade to pass over the upper surface of the screen to help move the CSP gel over the screen and to help force the NCSP liquid downwardly through the screen is particularly useful in making the pectin. If needed, additional filtration can be performed to further increase the clarity of the NCSP.

In another embodiment of the present invention, the NCSP has a degree of esterification (DE) of at least 70. Preferably, the NCSP has a DE of at least about 73. Most preferably, the DE is at least about 75. The DE of the NCSP could be as high as 100. Preferably, the DE is up to about 90. The most preferred upper limit for DE is about 80.

### Determination of Degree of Esterification and Galacturonic Acid in Non-Amide Pectin

The degree of esterification (DE) and galacturonic acid (GA) in non-amide pectin can be determined as presented below. This method is a modification of the Food Chemicals Codex and Food and Agriculture Organization of the United Nations/World Health Organization method for determination of % DE and % GA in pectin which does not contain amide and acetate ester.

The apparatuses needed to conduct this method include: an analytical balance; a glass beaker (250 ml.); a measuring glass (100 ml); a vacuum pump; a suction flask; a glass filter crucible no. 1 (Büchner funnel and filter paper); a stop watch; a test tube; a drying cabinet at 105 C; a desiccator; a magnetic stirrer and magnets; a burette (10 ml, accuracy 0.05 ml); pipettes (20 ml, 10 ml:); and a pH-meter/autoburette or phenolphtalein.

The chemicals required in this method include: carbon dioxide-free water; 60% and 100% isopropanol (IPA); 0.5 N and fuming 37% hydrochloride (HCl); 0.1 N and 0.5N sodium hydroxide (NaOH) (corrected to four decimals, e.g., 0.1002); 0.1 N silver nitrate 9 (AgNO₃); 3 N nitric acid (NHO₃); and indicator, 0.1% phenolphtalein (indicator).

The procedures for determining DE and GA are presented below. 2.000 g of pectin are weighed in a 250 ml glass beaker. 100 ml of acid alcohol are added and stirred on a magnetic stirrer for 10 minutes. The filtrate is thoroughly dried and the glass filter crucible is weighed. The beaker is completely rinsed with 6×15 ml acid alcohol. 60% IPA is washed until the filtrate is chloride-free (approximately 500 ml). The chloride test is conducted by transferring approximately 10 ml filtrate to a test tube, adding approximately 3 ml of 3 N HNO₃, and adding a few drops of AgNO₃. The filtrate is chloride-free if the solution is clear, otherwise there is a precipitation of silver chloride. 20 ml of 100% IPA is then washed. The sample is dried for 2.5 hours at 105° C. The crucible is weighed after drying and cooling in a desiccator. 0.4000 g of the sample is accurately weighed in a 250 ml glass beaker. (Two samples are weighed for double determination.) The pectin is soaked with approximately 2 ml of 100% IPA and approximately 100 ml of carbon dioxide-free water are added while stirring on a magnetic stirrer.

The sample is then titrated, either by means of an indicator or by using a pH-meter/autoburette. If an indicator is used, the method is continued to be carried out as follows: add 5 drops of phenolphtalein indicator and titrate with 0.1 N NaOH until change of color (record it as V₁ titer); add 20.00 ml of 0.5 N NaOH while stirring; and allow the solution to stand for exactly 15 min. When standing, the sample must be covered with foil. 20.00 ml of 0.5 N HCl are then added and stirred on a magnetic stirrer until the color disappears. 3 drops of phenolphtalein are added and titrated with 0.1 N NaOH until change of color (record it as V₂ titer). The blind test (double determination) is then carried out as follows: add 5 drops phenolphtalein to 100 ml carbon dioxide-free water and titrate in a 250 ml glass beaker with 0.1 N NaOH until change of color (1-2 drops); then add 20.00 ml 0.5 N NaOH and let the sample stand untouched for exactly 15 minutes. When standing, the sample must be covered with foil. 20.00 ml of 0.5 N HCl and 3 drops phenolphtalein are then added and titrated until change of color with 0.1 N NaOH. The amount of 0.1 N NaOH used is recorded as B₁. The maximum amount allowed for titration is 1 ml of 0.1 N NaOH. If titrating with more than 1 ml, 0.5 N HCl must be diluted with a small amount of deionized water. If the sample shows a change of color with the addition of 0.5 N HCl, 0.5 N NaOH must be diluted with a small amount of deionized water. The maximum amount of water allowed to be used is between 0.52 and 0.48 N.

If a pH-meter/autoburette is used, the method is continued to be carried out as follows: titrate each sample with 0.1 N NaOH to pH 8.5 (and the result is recorded as V₁, titer); then add 20.00 ml of 0.5 N NaOH and let the sample stand untouched for exactly 15 minutes. When standing the sample must be covered with foil. 20.00 ml of 0.5 N HCl are added and stirred on a magnetic stirrer until the pH is constant. The sample is then titrated with 0.1 N NaOH to pH 8.5. (The result is recorded as V₂ titer). The blind test (double determination) is carried out as follows: titrate 100 ml carbon dioxide-free water to pH 8.5 with 0.1 N NaOH (1-2 drops); add 20.00 ml of 0.5 N NaOH; and let the blind test sample stand untouched for exactly 15 minutes. When standing the sample must be covered with foil. 20.00 ml of 0.5 N HCl are added and stirred on a magnetic stirrer until pH is constant. The sample is then titrated to pH 8.5 with 0.1 N NaOH. The amount of 0.1N NaOH used is recorded as B₁. The maximum amount allowed for titration is 1 ml of 0.1 N NaOH. If titrating with more than 1 ml, 0.5 N HCl must be diluted with a small amount of deionized water. If pH does not fall to below 8.5 on addition of 0.5 N HCl, 0.5 N NaOH must be diluted with a small amount of deionzed water. The maximum amount of water allowed to be used in the dilution is between 0.52 and 0.48 N.

The degree of esterification (DE), degree of free acid (DFA), and degree of galacturonic acid (GA) are calculated by the following formulas:

Vₜ=V₁+(V₂−B₁)

$$\% DE \text{(Degree of esterification)} = \frac{( {V}_{2} - {B}_{1} ) \times 100}{{V}_{1}}$$

%D.F.A.(Degree of free acid)=100−% DE

$$\% GA \text{(Degree of galacturonic acid)} = \frac{194.1 \times {V}_{t} \times N \times 100}{400}$$

The percentage of GA is determined on ash and moisture-free basis. The value 194.1 is the molecular weight for GA. “N” is the corrected normality for 0.1 N NaOH. used for titration (e.g., 0.1002 N). The value 400 refers to the weight in mg of washed and dried sample for titration.

The invention will now be described with respect to certain examples which are merely representative of the invention and should not be construed as limiting thereof

### EXAMPLES

The invention is illustrated in the following non-limiting examples, which are provided for the purpose of representation, and are not to be construed as limiting the scope of the invention. All parts and percentages in the examples are by weight unless indicated otherwise.

### Example 1

### Fractionation of Pectin to Isolate NCSP-Illustrative Example

1000 g of pure pectin was dissolved in 50 Kg distilled (DI) water by heating to 70° C. and cooling to approximately 20° C. The pure pectin contained less than approximately 5 mg of calcium or other di or trivalent cations per gram of pectin. The pH of the solution was adjusted to 4.0 using either a suitable acid or base.

The solution was mixed under gentle stirring with an equal amount of a solution containing 338.7 Kg DI water, 9.9 Kg IPA, and 0.66 Kg CaCl₂·6H₂O.

After mixing the two solutions, the resulting gel suspension contained a calcium ion concentration of 30 mM and an IPA content of 8% (w/w). The suspension of the gel particles that were formed were allowed to set for two hours with occasional stirring. The gel particles were separated from the liquid phase and washed twice with equal amounts of a solution containing 30 mM calcium and 8% IPA. The time for each wash was two hours.

The gel phase was set aside. The pectin contained in the liquid phase was isolated by mixing it with two volumes of 80% IPA. The precipitated pectin was recovered and washed twice with 60% IPA, dried, weighed, and milled to reduce its particle size.

TABLE 1

| | Starting Material | NCSP Fraction |
|---|---|---|
| DE | 71.5 | 78.5 |
| AGA %* | 83.1 | 86.4 |
| CS | 360 | 0.1 |
| % of Fractions | 100 | 39 |

*AGA is anhydrogalacturonic acid content (wt %)

### Example 2

### Solution Clarity of NCSP Samples

Following the procedure described above in Clarity of a 1% Pectin solution, a 1% solution of GENU VIS™ pectin typically has a % Transmittance value (%T) of 60 to 70 while NCSP consistently has a %T value of greater than 85. Solutions of NCSP are significantly more clear than conventional pectin types (Table 2).

### Example 3

### Viscosity of NCSP Solutions

The viscosity is determined at 25° C. using a Brookfield Viscosimeter type LVT with a sample adapter in a 4% pectin solution which is made up at 25° C. in a medium containing hexametaphosphate and a pH adjusted to 4.0.

Apparatus

1. Brookfield Digital Viscosimeter (model DV-11)

2. Brookfield small sample adapter assembly with temperature controlled sample chamber

3. Brookfield spindle no. 34

4. Temperature controlled water bath, 25° C.

5. Balance capable of weighing to 0.01 g

6. Magnetic stir plate

7. pH meter

Materials and Reagents

1. Citrus pectin

2. Deionized water

3. Sodium hexametaphosphate

4. Weighing dish or paper

5. 250 ml glass beaker

6. Teflon coated stir bar (1×⅜″)

7. Stainless steel spoon or scoopula

8. Saturated sodium bicarbonate solution, NaHCO₃

9. Concentrated phosphoric acid solution, H₃PO₄

Procedure

A) Sample Preparation

1. Prepare 1 liter of a 1.0% (w/v) solution of sodium hexametaphosphate.

2. Weigh 96 g sodium hexametaphosphate solution (1% w/v) in the 250 ml beaker.

3. Add the stir bar to the beaker and place on the magnetic stir plate.

4. Weigh 4.00 g citrus pectin in the weighing dish.

5. Turn the stirrer on high and slowly add the dry pectin to the 250 ml beaker. If the pectin is added to the sodium hexametaphosphate too quickly, it will not disperse properly and result in clumping.

6. Let stir for a minimum of 2 hours making sure that all the pectin has dissolved. After all pectin is dissolved, adjust the pH to 4.00±0.05 with NaHCO₃ or H₃PO₄ while the solution is stirring.

Viscosity Measurement

1. Allow the pectin solution to stand for 30 minutes to let the air rise to the surface.

2. Skim off the foam layer from the solution.

3. Weigh 1.0 g of the pectin solution into the small sample adapter chamber at a 45° angle to prevent the entrapment of air in the sample.

4. Guide the sample chamber into position

5. Allow the sample to equilibrate at 25° C. for 5 minutes.

6. Turn on the Viscosimeter. The spindle rotation should be set to 60 rpm.

7. The viscosity of the soluton is displayed in centipoise (cP) on the Viscosimeter LED readout.

### Example 4

### Fractionation of Pectin to Isolate NCSP-Preferred Method

Pectin is extracted from lemon peel and then fractionated to obtain NCSP precusor.

10 kg of dried lemon peel (Argentina) is added to a 500 liter stirred tank reactor. 500 liters of deionized water is then added to the peel in the reactor. 0.8 liter of nitric acid (62 wt. % HNO₃, Olin Corp., Chemicals Group, Norwalk, Conn. 06856 USA) is further added to the reactor to reach a pH of 0.9 to 1.2.

Pectin is extracted from the mixture of lemon peel by heating the mixture with slight agitation to 70° C. for 3 hours. The extraction mixture is then filtered using vacuum filtration followed by a vacuum polishing filtration using Celite (Celite Corp., c/o World Minerals Inc. Lompoc, Calif. 93438 USA).

The filtrate is evaporated using a wiped film evaporator to increase the pectin concentration in solution to approximately 1.6% w/w. The pH of the clear filtrate is adjusted to 4.0 by the addition of a sodium carbonate solution (Na₂CO₃, CERAC, Inc. Milwaukee, Wis. 53201 1178 USA).

1000 Kg of the 1.6% pectin thick juice is then mixed with 1500 Kg of IPA/calcium solution to produce a mixture composition of 0.9% (w/w) pectin, 6.8% (w/w) IPA and 2,000 ppm calcium at pH 4.0. This mixture is allowed to gel. The gel particles are separated form the liquid portion using screens to hold the gel but allow the liquid to pass through. The gel phase contains the CSP fraction. The liquid phase contains the desired NCSP fraction. The gels are washed over a series of 4 screens with IPA/Calcium mixture in a counter-current fashion. After washing is completed, the liquid phase is concentrated by evaporation, calcium is removed by ion exchange. Optionally, the dry NCSP precursor is isolated by precipitation with 2 volumes of 60% IPA. In this case, the pectin is belt pressed. The pressed pectin is dried and ground.

The ability to provide the desired organoleptic properties, such as body and mouthfeel, is believed to be related, at least in part, to the ability of pectin to increase the viscosity of the solution in which it is dissolved. As can be seen in Table 2, typical NCSP production samples have viscosity in the 300 to 450 cPs. range, standardized basis. Samples 1-4 reported in Table 2 were made as indicated above but on different days using different peel sources. Sample 1 has a 2% viscosity of 413 cPs at a gum level of 52.3%. (Table 2). Comparative Example 1 shows the actual product specifications and specification ranges for GENU VIS grade pectin, manufactured by CPKelco, Wilmington, Del. Comparative Example 2 shows data from an actual GENU VIS (manufactured by CPKelco, Wilmington, Del.) sample analyzed by the indicated methods.

TABLE 2
GENU Pectin Type VIS & NCSP for VIS Applications

| | Comparative | Comp. | NCSP | | | |
|---|---|---|---|---|---|---|
| Property | Example 1 | Example 2 | Sample 1 | Sample 2 | Sample 3 | Sample 4 |
| Standardization | 50-100 | 50 | 52.3 | 100 | 100 | 100 |
| (% gum) | | | | | | |
| SAG Grade | n/a | 240 | n/a | 242 | 227 | 236 |
| Viscosity (cPs) | 450-550 | 475 | 413 | 440⁽²⁾ | 292⁽²⁾ | 386⁽²⁾ |
| Solution Clarity | >40 | 65 | 85 | 81 | 91 | 91 |
| (% T) | | | | | | |
| DE (%) | >70 | 71 | 75 | 75.1 | 75.0 | 77.4 |
| Mw | n/a | 110-135 | 117 | 127.3 | 106.7 | 113.0 |
| (,000 g/mole) | | | | | | |
| CS+ (cP) | n/a | >100 | n/a | 16.2 | 11.1 | 11.1 |
| Calcium (ppm) | <1500 | <1000 | 260 | 600 | 440 | 890 |

⁽¹⁾Composition of Sample 1 = 26.25% Sample 2, 26.5% Sample 3 and 47.5% sugar
⁽²⁾Measured at 2% pure pectin basis

### Example 5

One example of a clear beverage that tends to lose body or mouthfeel when manufactured on a large, commercial scale is wine. Traditionally, wine is clarified by fining and/or filtration. If either of these operations is done to such an extent to insure complete clarity and lack of sediment, the proteins and polymers that contribute to mouthfeel are lost. It is often desirable to add back ingredients that can rebuild the viscosity, body, and mouthfeel, without causing cloudiness (which is always viewed as a negative with wine) or sediment (which is often viewed as a negative).

It has been found that NCSP can be used to provide the desired increase in viscosity consistent with standard GENU VIS® pectin, without the undesirable cloudiness. Further, it has been observed that this behavior is consistent for both aqueous and ethanol-containing solutions.

In a series of experiments conducted using commercially available wines, an NCSP sample (Sample 1 from Example 3) was compared to conventional GENU VIS® type pectin for viscosity and solution clarity. A 1% or 2% aqueous solution of these standardized pectins was added to the wine samples (white, blush, red, burgundy) to achieve a final pectin concentration (standardized basis) of 0.1%, 0.2%, and 0.4%. The Sample 1 NCSP resulted in equivalent or slightly higher viscosity than the VIS sample. However, Sample 1 consistently resulted in superior clarity, as compared to VIS pectin both as a function of concentration and as a function of storage time.

### Example 6

In a separate experiment, an unstandardized NCSP (Sample 4 from Example 3) was used to achieve higher pectin concentrations, on a pure pectin basis, and to increase the viscosity of wine samples. In this case, the goal was to achieve reduced alcohol concentrations in the final wine samples and to rebuild any lost body and/or mouthfeel with the pectin. As can be seen in the below tables, only very low concentrations of pectin (0.0625% or less) were required to meet or exceed the viscosity of the control wine sample (sample #6 in both cases). All samples were of extremely high clarity.

TABLE 3
WHITE WINE- FRENCH COULOMBARD
Stock Pectin Solution Conc. = 2.0% pectin, 200 mls
Prepared wine solutions @ 75/25 ratio (wine/pectin solution)

| | Stock Pectin | | | | LV viscosity |
|---|---|---|---|---|---|
| | Solution | Water | Wine | Pectin Conc. | @ 30 rpm |
| Sample | (mls) | (mls) | (mls) | In Wine (%) | (cPs) |
| 1 | 75.00 | 0.00 | 225 | 0.5 | 12.5 |
| 2 | 37.50 | 37.50 | 225 | 0.25 | 4.74 |
| 3 | 18.75 | 56.25 | 225 | 0.125 | 2.74 |
| 4 | 9.38 | 65.63 | 225 | 0.063 | 2.48 |
| 5 | 0.00 | 75.00 | 225 | 0 | 1.44 |
| 6 | 0.00 | 0.00 | 300 | 0 | 1.54 |

TABLE 4
RED ROSE
Stock Pectin Solution Conc. = 1.25% pectin, 400 mls
Prepared wine solutions @ 60/40 (wine/pectin solution)

| | Stock Pectin | | | | LV viscosity |
|---|---|---|---|---|---|
| | Solution | Water | Wine | Pectin Conc. | @ 30 rpm |
| Sample | (mls) | (mls) | (mls) | In Wine (%) | (cPs) |
| 1 | 120 | 0 | 180 | 0.5 | 12 |
| 2 | 60 | 60 | 180 | 0.25 | 4.44 |
| 3 | 30 | 90 | 180 | 0.125 | 2.56 |
| 4 | 15 | 105 | 180 | 0.063 | 1.94 |
| 5 | 0 | 120 | 180 | 0 | 1.42 |
| 6 | 0 | 0 | 300 | 0 | 1.76 |

### Example 7

A series of experiments were completed to compare the clarity of Sample 1, GENU VIS® and Sample 4 at 0.5% in solutions containing ethanol at a concentration ranging from 0 to 30%. Samples 1 and 4 were significantly and consistently higher in clarity, as compared to the GENU VIS® sample at ethanol levels typical of wine (<15%).

### Example 8

### Determination of the Calcium Sensitivity of a Pectin Sample

Reagents:

1.000 M HCl

1M acetate buffer pH 4.75: 500 mM CH₃COONa, 3H₂O:68.04 g/l and 500 mM CH₃COOH 100%:28.6 ml/l

250 mM calcium chloride: CaCl₂, 2H₂O: 36.7550 g/l

Ion exchanged water with a conductivity below 1.0 uS/cm must be used in all solutions.

Pectin Solution:

Make up a 400 g pectin solution with 2.4 g of pure gum (0.6% sol.).

When testing samples which are not 100% gum (pure gum), correct according to the following formula (A=the gum % of the sample):

$$\frac{0.6 \times 400}{A} = \begin{matrix}\text{g sample with A \% gum to prepare 400 g} \\ \text{solution with 0.6\% final concentration}\end{matrix}$$

Procedure:

1. Weigh out the pectin with the adjusted sugar percentage to 3 decimals.

2. Disperse the pectin into 240 ml of boiling ion-exchanged water in a high shear mixer.

3. Pour the solution into a tared beaker with magnet.

4. Pour an additional 100 ml of ion exchanged water into the mixer and add to the solution.

5. Cool the pectin solution to 25° C.

6. Adjust the pectin solution to a pH of 1.5 with 1 M HCl.

7. The solution is weighed up to 400 g.

8. Weigh out 145 g±1 g of the pectin solution in a viscosity glass

9. Add 5 ml 250 mM Ca⁺⁺ solution to the pectin solution while stirring with the plate magnetic stirrer at step 1. Stir for 2 minutes.

10. Add 25 ml 1 M acetate buffer with dispenser to the glass while stirring with a magnetic stirrer (JK IKA-Combimag REO). pH should now be approx. 4.2.

11. By means of the plate magnetic stirrer at step 1, stir for an additional 2 minutes.

12. Remove the magnet and let the solution rest at 25° C. until the next day.

13. The viscosity is measured using the Brookfield LVT viscometer at 60 rpm. at 25° C. (use the thermostatically controlled water bath).

14. The calcium sensitivity is given as viscosity measured in cP.

What is claimed is:

1. A beverage product comprising a beverage and pectin, wherein the pectin has a calcium sensitivity of less than 20 cPs and the beverage product has a solution clarity of greater than 70% T.

2. The beverage product of claim 1, wherein the pectin has a calcium sensitivity of less than about 15 cPs.

3. The beverage product of claim 1, wherein the pectin has a calcium sensitive pectin ratio of less than 10%.

4. The beverage product of claim 2, wherein the pectin has a calcium sensitive pectin ratio of less than 10%.

5. The beverage product of claim 1, wherein the pectin has a DE greater than 70.

6. The beverage product of claim 3, wherein the pectin has a DE greater than 70.

7. The beverage product of claim 4, wherein the pectin has a DE greater than 70.

8. The beverage product of claim 1, wherein the solution clarity is at least about 80% T.

9. The beverage product of claim 2, wherein the solution clarity is at least about 80% T.

10. The beverage product of claim 4, wherein the solution clarity is at least about 80% T.

11. The beverage product of claim 7, wherein the solution clarity is at least about 80% T.

12. The beverage product of claim 1, wherein the pectin has a calcium sensitivity of less than about 10 cPs.

13. The beverage product of claim 3, wherein the pectin has a calcium sensitivity of less than about 10 cPs.

14. The beverage product of claim 6, wherein the pectin has a calcium sensitivity of less than about 10 cPs.

15. The beverage product of claim 8, wherein the pectin has a calcium sensitivity of less than about 10 cPs.

16. The beverage product of claim 7, wherein the pectin has a calcium sensitive pectin ratio of less than about 7%.

17. The beverage product of claim 12, wherein the pectin has a calcium sensitive pectin ratio of less than about 7%.

18. The beverage product of claim 13, wherein the pectin has a DE greater than about 73.

19. The beverage product of claim 1, further comprising at least one of vitamin, flavor, preservative, color, mineral, sugar, natural sweetener, artificial sweetener and nutrients.

20. The beverage product of claim 4, further comprising at least one of vitamin, flavor, preservative, color, mineral, sugar, natural sweetener, artificial sweetener and nutrients.

21. The beverage product of claim 7, further comprising at least one of vitamin, flavor, preservative, color, mineral, sugar, natural sweetener, artificial sweetener and nutrients.

22. The beverage product of claim 2, wherein the pectin is present in an amount of at least 0.025% on a weight basis of the total amount of beverage.

23. The beverage product of claim 16, wherein the pectin is present in an amount of at least 0.025% on a weight basis of the total amount of beverage.

24. The beverage product of claim 17, wherein the pectin is present in an amount of at least 0.025% on a weight basis of the total amount of beverage.

25. The beverage product of claim 2, wherein the solution clarity is at least about 90% T.

26. The beverage product of claim 2, wherein the pectin is present in an amount of at least 0.05% on a weight basis of the total amount of beverage.

27. The beverage product of claim 4, wherein the pectin is present in an amount of at least 0.05% on a weight basis of the total amount of beverage.

28. The beverage product of claim 7, wherein the pectin is present in an amount of at least 0.05% on a weight basis of the total amount of beverage.

29. The beverage product of claim 1, wherein the pectin has a calcium sensitivity of less than about 5 cPs.

30. The beverage product of claim 3, wherein the pectin has a calcium sensitivity of less than about 5 cPs.

31. The beverage product of claim 5, wherein the pectin has a calcium sensitivity of less than about 5 cPs.

32. The beverage product of claim 7, wherein the pectin has a calcium sensitivity of less than about 5 cPs.

33. The beverage product of claim 17, wherein the pectin has a calcium sensitivity of less than about 5 cPs.

34. The beverage product of claim 24, wherein the pectin has a calcium sensitivity of less than about 5 cPs.

35. The beverage product of claim 1, wherein the pectin has a DE of greater than about 75.

36. The beverage product of claim 4, wherein the pectin has a DE of greater than about 75.

37. The beverage product of claim 7, wherein the pectin has a DE of greater than about 75.

38. The beverage product of claim 14, wherein the pectin has a DE of greater than about 75.

39. The beverage product of claim 1, wherein the pectin is processed pectin.

40. The beverage product of claim 2, wherein the pectin is processed pectin.

41. The beverage product of claim 4, wherein the pectin is processed pectin.

42. The beverage product of claim 7, wherein the pectin is processed pectin.

43. The beverage product of claim 14, wherein the pectin is processed pectin.

44. The beverage product of claim 1, wherein the solution clarity is at least about 90% T.

45. The beverage product of claim 4, wherein the solution clarity is at least about 90% T.

46. The beverage product of claim 1, further comprising alcohol.

47. The beverage product of claim 7, further comprising alcohol.

48. The beverage product 7, wherein the beverage is wine.

49. The beverage product of claim 44, wherein the wine is non-vintage, jug or boxed wine.

50. The beverage product of claim 1, wherein the pectin has a clarity greater than 65% T.

51. The beverage product of claim 2, wherein the pectin has a clarity greater than 65% T.

52. The beverage product of claim 3, wherein the pectin has a clarity greater than 65% T.

53. The beverage product of claim 4, wherein the pectin has a clarity greater than 65% T.

54. The beverage product of claim 7, wherein the pectin has a clarity greater than 65% T.

55. The beverage product of claim 14, wherein the pectin has a clarity greater than 65% T.

56. The beverage product of claim 46, wherein the pectin has a clarity greater than about 75% T.

57. The beverage product of claim 49, wherein the pectin has a clarity greater than about 75% T.

58. The beverage product of claim 50, wherein the pectin has a clarity greater than about 75% T.

59. The beverage product of claim 51, wherein the pectin has a clarity greater than about 75% T.

60. The beverage product of claim 46, wherein the pectin has a clarity greater than 85% T.

61. The beverage product of claim 47, wherein the pectin has a clarity greater than 90% T.

62. The beverage product of claim 1, wherein the beverage is one of water, sports drinks, juices, soft drinks, bottled beer, draft beer, malt beverages, liquors, vintage, non-vintage, jug and boxed wine, wine coolers, diluted wine beverage, varietal and non-varietal and refreshing drinks.

63. The beverage product of claim 1, wherein the pectin is NCSP.

64. The beverage product of claim 38, wherein the pectin has a calcium sensitivity less than about 5 cPs.

65. The beverage product of claim 7, wherein the pectin has a calcium sensitive pectin ratio of less than 10%.

66. The beverage product of claim 7, wherein the pectin has a calcium sensitive pectin ratio of less than 5%.

67. The beverage product of claim 7, wherein the pectin has a calcium sensitive pectin ratio of less than 1%.

68. The beverage product of claim 1, further comprising charged material.

69. The beverage product of claim 68, wherein the charged material is at least one of polyvalent cation, protein or finely divided insoluble or colloidal particles.

70. The beverage product of claim 69, wherein the charged material is at least one cation.

71. The beverage product of claim 70, wherein the cation is polyvalent.

72. The beverage product of claim 71, wherein the cation comprises calcium.

73. The beverage product of claim 1, wherein the pectin has a molecular weight of at least 50,000 g/mole.

74. The beverage product of claim 4, wherein the pectin has a molecular weight of at least 50,000 g/mole.

75. The beverage product of claim 13, wherein the pectin has a molecular weight of at least 50,000 g/mole.

76. The beverage product of claim 75, wherein the pectin has a molecular weight of at least 75,000 g/mole.

77. The beverage product of claim 76, wherein the pectin has a molecular weight of at least 100,000 g/mole.

78. The beverage product of claim 38, wherein the solution clarity is at least about 90% T.

79. A process for making a beverage product comprising mixing pectin and a beverage, wherein the pectin has a calcium sensitivity of less than 20 cPs and wherein the beverage product has a solution clarity of greater than 70% T.

80. A beverage product comprising a beverage, at least one of vitamin, flavor, preservative, color, mineral, sugar, natural sweetener, artificial sweetener and nutrient, and pectin having a molecular weight greater than 50,000 g/mole, wherein the pectin is present in an amount of at least about 0.05% on a weight basis of the total amount of beverage, has a clarity of greater than about 75% T, has a calcium sensitivity of less than about 10 cPs, and has a calcium sensitive pectin ratio of less than 5%.

81. A pectin-containing beverage concentrate to be reconstituted with water or any other orally ingestible liquid as a drinkable liquid, comprising beverage concentrate and pectin, wherein the pectin has a calcium sensitivity of less than 20 cPs and said pectin-containing concentrate, upon reconstitution, has a solution clarity of greater than 70% T.

82. The pectin-containing beverage concentrate of claim 81, further comprising at least one of vitamin, flavor, preservative, color, mineral, sugar, natural sweetener, artificial sweetener and nutrient.

83. A pectin-containing beverage concentrate to be reconstituted with water or any other orally ingestible liquid as a drinkable liquid, comprising solid beverage concentrate and pectin, wherein the pectin has a calcium sensitivity less than 20 cPs and the pectin-containing beverage concentrate, upon reconstitution, has a solution clarity of greater than 70% T.

84. The pectin-containing beverage concentrate of claim 83, further comprising at least one of vitamin, flavor, preservative, color, mineral, sugar, natural sweetener, artificial sweetener and nutrient.

85. A pectin-containing beverage concentrate to be reconstituted with water or any other orally ingestible liquid as a drinkable liquid, comprising beverage concentrate and pectin, wherein the pectin has a clarity greater than 65% T and wherein the pectin-containing beverage concentrate, upon reconstitution, has a solution clarity of greater than 70% T.

86. The pectin-containing beverage concentrate of claim 85, further comprising at least one of vitamin, flavor, preservative, color, mineral, sugar, natural sweetener, artificial sweetener and nutrient.

87. The pectin-containing beverage concentrate of claim 86, wherein the pectin has a molecular weight of at least 50,000 g/mole

88. A pectin-containing beverage concentrate to be reconstituted with water or any other orally ingestible liquid as a drinkable liquid, comprising solid beverage concentrate and pectin, wherein the pectin has a clarity greater than 65% T and wherein the pectin-containing beverage concentrate, upon reconstitution, has a solution clarity of greater than 70% T.

89. The pectin-containing beverage concentrate of claim 88, further comprising at least one of vitamin, flavor, preservative, color, mineral, sugar, natural sweetener, artificial sweetener and nutrient.

90. The pectin-containing beverage concentrate of claim 89, wherein the pectin has a molecular weight of at least about 50,000 g/mole

91. A beverage product comprising a beverage and pectin, wherein the pectin has a clarity of greater than 65% T and the beverage product has a solution clarity of greater than 70% T.

92. The beverage product of claim 91, wherein the beverage is one of water, sports drinks, juices, soft drinks, bottled beer, draft beer, malt beverages, liquors, vintage, non-vintage, jug and boxed wine, wine coolers, diluted wine beverage, varietal and non-varietal and refreshing drinks.

93. A process for making a beverage product comprising mixing pectin and a beverage, wherein the pectin has a clarity greater than 65% T and wherein the beverage product has a solution clarity of greater than 70% T.
